(19) United States
(12) Patent Application Publication
(10) Pub. No.: US 2003/0011631 A1
(43) Pub. Date: Jan. 16, 2003

(54) System and method for document division

(76) Inventor: Erez Halahmi, Petach Tikva (IL)

Correspondence Address: Anthony Castorina, GE Ehrlich, Suite 207, 2001 Jefferson Davis Highway, Arlington, VA, 22202, US

(21) Appl. No.: 10/220,199

(22) PCT Filed: Feb. 28, 2001
(86) PCT No.: PCT/IL01/00189

(51) Int. Cl. G09G 5/00

(52) U.S. Cl. 345/744

(57) ABSTRACT

A method and a system for dividing documents into a plurality of smaller portions, for example for easier transmission and/or display of the document. The system and method enable the user to quickly receive and display each portion of the document, rather than waiting for the entire document to be downloaded before any part is displayed. According to preferred embodiments, navigational capabilities are also provided, such that the user is optionally able to move between portions by selecting an icon for example, and even to view the portions of the document in a different order than the linear sequence itself. Thus, the user is able to view portions without waiting for the entire document to be downloaded to the device, optionally and preferably in the order of interest, rather than only according to the order in which they are downloaded.

### FIELD AND BACKGROUND OF THE INVENTION

The present invention relates to a system and method for the automatic division of documents into a plurality of smaller portions for transmission and/or display of each portion, and in particular, for a system and method which enables documents based on elements, tags, frames or other delineated sections to be so divided, for example for transmission and display by a WAP (wireless application protocol) enabled device.

Cellular telephones are becoming increasingly popular for portable telephone use, particularly for users who are interested in rapid, mobile communication. As the amount of computational power and memory space which are available in such small, portable electronic devices becomes increased, a demand has arisen for different types of communication services through such devices. In particular, users have demanded that cellular telephones receive many different types of multimedia data, including e-mail (electronic mail) messages and Web pages.

In response to such demands, and to extend the power and efficacy of operation of portable, wireless electronic communication devices, the WAP (wireless application protocol) defacto standard has been developed. WAP is now the standard for the presentation and delivery of wireless data, including multimedia and other information, and telephony services, on mobile telephones and other types of wireless communication devices. WAP is designed to efficiently provide both multimedia and telephony services to such wireless communication devices, given the limitations of wireless networks and of the electronic devices themselves.

Wireless communication devices have requirements and drawbacks which are different than cable-linked electronic devices. For example, wireless networks are frequently significantly less stable than cable networks. Since users with such portable communication devices often operate these devices at different locations, the wireless network connection may not always be available, and may even suddenly become unavailable during a single communication session. In addition, the wireless communication devices themselves are more limited in terms of available resources than desktop computers. For example, such wireless communication devices typically have a less powerful CPU (central processing unit), less memory, a lower amount of available power since these devices are often battery-operated, and smaller display screens. Thus, wireless communication devices require adaptations of existing software and data transmission protocols in order to effectively deliver multimedia content from the Internet.

WAP provides the required adaptations and modifications to such software and data transmission protocols in order to meet the requirements of wireless communication devices. For example, HTML (Hyper-text Mark-up Language) has been adapted to form WML (Wireless Mark-up Language), which provides a document mark-up language suitable for WAP-enabled devices and their corresponding limitations WAP-enabled devices are able to receive and display documents written in WML, thereby enabling such devices to display Web pages which are written in WML, for example.

Unfortunately bandwidth considerations still limit the amount of data which can be rapidly received by WAP-enabled devices, such as cellular telephones for example. Therefore, the user may be forced to wait for a significant period of time before an entire Web page is downloaded for display by the WAP-enabled device. Furthermore, the user may not even wish to view the entire Web page or other document, but only a portion of such a document. If that portion is located near the end of the document, then the user must wait for data which is not of interest to be downloaded, before the portion of interest can be received by the WAP-enabled device. This problem is particularly acute for documents which are not originally designed for display by a WAP-enabled device, such as Web pages which were originally written in HTML for example, and hence which may require extensive bandwidth resources in order to be received and displayed.

Translation solutions are available for translating between different mark-up languages, such as between WML and HTM for example. Transcoding technology has been proposed for altering Web pages to be suitable for display on different types of devices (IBM Ltd., USA; see for example http://www.research.ibm.com/networked_data_systems/transcoding as of Feb. 16, 2000). However, such technology is only described as being useful for translating and converting documents between different formats. The problem of downloading an entire large document over a limited bandwidth connection, before being able to view any part of it, is not addressed by such conversion and translation.

A more useful solution would enable the user to receive the document in portions, such that the user could optionally select only one or two portions to be viewed. Preferably, the user could also select each portion without regard to the location of that portion within the document, such that the user could optionally choose to view the last portion of the document before viewing other portions, for example. Unfortunately, such a solution is not currently available.

There is thus a need for, and it would be useful to have, a system and a method for dividing a document into a plurality of smaller portions, particularly documents based on elements, tags, frames or other delineated sections, such that each portion is optionally transmitted and displayed separately, for example to a WAP-enabled device such as a cellular telephone for example.

### BRIEF DESCRIPTION OF THE DRAWINGS

The foregoing and other objects, aspects and advantages will be better understood from the following detailed description of a preferred embodiment of the invention with reference to the drawings, wherein:

FIG. 1 is a schematic block diagram of a system according to the present invention;

FIG. 2 is a flowchart of an exemplary method according to the present invention for dividing a document into a plurality of portions;

FIGS. 3A and 3B show part of an exemplary document before (3A) and after (3B) the method of FIG. 2 has been performed;

FIG. 4 is a flowchart of an exemplary method for navigating between portions according to the present invention; and

FIG. 5 is an exemplary display of a portion by a display screen of a wireless communication device according to the present invention.

### SUMMARY OF THE INVENTION

The present invention is of a method and a system for dividing documents into a plurality of smaller portions, for example for more rapid transmission and/or display of the document. The present invention enables the user to quickly receive and display each portion of the document, rather than waiting for the entire document to be downloaded before any part is displayed. According to preferred embodiments of the present invention, navigational capabilities are also provided, such that the user is optionally able to move between portions by selecting an icon for example, and even to view the portions of the document in a different order than the linear sequence itself. Thus, the user is able to view portions without waiting for the entire document to be downloaded to the device, optionally and preferably in the order of interest, rather than only according to the order in which they are downloaded.

According to the present invention, there is provided a method for dividing a document into a plurality of portions for display to a user, the method comprising the steps of: (a) providing a display device for displaying at least one portion to the user and a network connected to the display device; (b) determining at least one property of the display device; (c) dividing the document into the plurality of portions, such that each portion is at least partially determined according to the at least one property of the display device; (d) receiving at least one portion of the plurality of portions through the network by the display device; and (e) displaying the at least one portion by the display device.

According to another embodiment of the present invention, there is provided a system for dividing a document into a plurality of portions for display to a user, the document featuring a plurality of delineated sections, each delineated section featuring at least one attribute, the system comprising: (a) a low bandwidth communication device for displaying at least one portion to the user, the low bandwidth communication device having at least one property; (b) a server for dividing the document into the plurality of portions at least partially according to the at least one property, such that each portion features at least one attribute of a corresponding delineated section of the document, and for sending at least one portion to the low bandwidth communication device; and (c) a network for connecting the low bandwidth communication device to the server.

According to yet another embodiment of the present invention, there is provided a method for navigating within a document by a user, the document being divided into a plurality of portions, the method comprising the steps of: (a) providing a low bandwidth device for displaying at least one portion to the user; (b) adding a navigation option to at least one portion of the plurality of portions; (c) displaying the navigation option by the low bandwidth device; (d) selecting the at least one portion by the user with the navigation option; (e) receiving the at least one portion by the low bandwidth device; and (f) displaying the at least one portion by the low bandwidth device.

Hereinafter, the term “network” refers to a connection between any two electronic devices which permits the-transmission of data.

Hereinafter, the term “wireless device” refers to any type of electronic device which permits data transmission through a wireless channel, for example through transmission of radio waves. Hereinafter, the term “cellular phone” is a wireless device designed for the transmission of voice data and/or other data, optionally through a connection to the PSTN (public switched telephone network) system.

Hereinafter, the term “computational device” includes, but is not limited to, personal computers (PC) having an operating system such as DOS, Windows™, OS/2™ or Linux; Macintosh™ computers; computers having JAVA™-OS as the operating system; graphical workstations such as the computers of Sun Microsystems™ and Silicon Graphics™, and other computers having some version of the UNIX operating system such as AIX™ or SOLARIS™ of Sun Microsystems™; or any other known and available operating system, or any device, including but not limited to: laptops, hand-held computers, cellular telephones, wearable computers of any sort, and WAP-enabled devices, as well as any device which can be connected to a network as previously defined and which have an operating system. Hereinafter, the term “Windows™” includes but is not limited to Windows95™, Windows 3.x™ in which “x” is an integer such as “1”, Windows NT™, Windows98™, Windows CE™, Windows2000™, and any upgraded versions of these operating systems by Microsoft Corp. (USA).

Hereinafter, the term “Web browser” refers to any software program which can display text, graphics, or both, from Web pages on World Wide Web sites. Hereinafter, the term “Web page” refers to any document written in a mark-up language including, but not limited to, HTL (hypertext mark-up language) or VRML (virtual reality modeling language), dynamic HTML, XML (extended mark-up language), WML (wireless mark-up language), or related computer languages thereof, as well as to any collection of such documents reachable through one specific Internet address or at one specific World Wide Web site, or any document obtainable through a particular URL (Uniform Resource Locator). Hereinafter, the term “Web site” refers to at least one Web page, and preferably a plurality of Web pages, virtually connected to form a coherent group. Hereinafter, the term “Web server” refers to software, or a combination of hardware and software, such as a software program operated by a computational device, which is capable of transmitting at least one Web page upon request by a Web browser.

Hereinafter, the phrase “display a Web page” includes all actions necessary to render at least a portion of the information on the Web page available to the computer user. As such, the phrase includes, but is not limited to, the visual display of graphical information, the audible production of audio information, the animated visual display of animation and the visual display of video stream data.

The method of the present invention could be described as a series of steps performed by a data processor, and as such could optionally be implemented as software, hardware or firmware, or a combination thereof. For the present invention, a software application could be written in substantially any suitable programming language, which could easily be selected by one of ordinary skill in the art. The programming language chosen should be compatible with the computer hardware and operating system according to which the software application is executed. Examples of suitable programming languages include, but are not limited to, C, C++, WMLscript and Java.

### DETAILED DESCRIPTION OF THE INVENTION

The present invention is of a method and a system for dividing documents into a plurality of smaller portions, for example for faster transmission and/or display of the document. The present invention is preferred for operation in environments with limited bandwidth and/or display capacity, such as for wireless handheld devices, for example. As previously described, such devices cannot easily receive large amounts of data, and also typically have relatively small display screens. Thus, the present invention enables the user to quickly receive and display each portion of the document, rather than waiting for the entire document to be downloaded before any part is displayed.

According to preferred embodiments of the present invention, navigational capabilities are also provided, such that the user is optionally able to move between portions by selecting an icon for example, and even to view the portions of the document in a different order than the linear sequence itself More preferably, a list of the portions is displayed, optionally with a short title which may be taken from the first line of the text for example, in order for the user to be able to select a portion of interest for viewing. Thus, the user could optionally and preferably view portions according to the interests of the user, rather than only according to the order in which they are downloaded.

As described in greater detail below, the present invention is particularly suitable for documents based on elements, tags, some type of mark-up language, frames or other delineated sections. By “delineated sections”, it is meant that each section has one or more associated attributes, which may be used to determine how the document is displayed. In the case of HTML, which uses tags, or WML, which uses elements, the delineations are clear between sections. Although each section does not necessarily need to form a separate portion for transmission and/or display, and indeed a section may be divided between a plurality of portions, the sections are useful for parsing the document in order to ensure that the associated data, such as text and/or graphics, for example, is properly displayed in each portion.

For other types of documents, such as word processing documents which may be written in either a standard or proprietary format, for example, each delineated section is optionally determined according to the internal formatting commands which control how the text and/or graphic data is displayed to the user. For example, text may be bold or italicized, images may be anchored to a page or may be allowed to move between pages, and the margins of each page may be set. Each such command refers to a section of text, such that only a few words may be emphasized with boldface type for example. The delineated section may even be as simple as a line or paragraph break, or even determined according to the words and/or graphical images of a document, such that the relative location of these components of the document determine the delineated sections. Thus, these documents may also be parsed according to the present invention, as described in greater detail below.

In addition, delineated sections may optionally be frames, for example for MPEG (Motion Picture Expert Group) video data, or for JPEG (Joint Photographic Expert Group) graphic data. Such data may also optionally be parsed as described in greater detail below, as the location of the frames can be used in order to determine the division of the document into portions.

The delineated sections of the document are optionally nested, such that a single segment of the document may contain a first section within a second section, for example. Nesting of such sections is typically present in mark-up language documents, such as HTML documents, in which tags may be nested for example.

The principles and operation of a system and a method according to the present invention may be better understood with reference to the drawings and the accompanying description, it being understood that these drawings are given for illustrative purposes only and are not meant to be limiting.

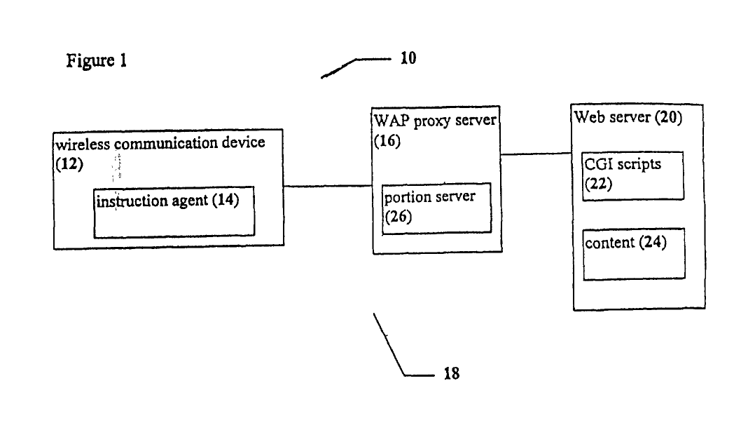

Referring now to the drawings, FIG. 1 is a schematic block diagram of a system according to the present invention for dividing a document into a plurality of smaller portions. Although the present invention is explained with regard to WAP and a WAP-enabled device, such as a cellular telephone for example, it is understood that this is for the purposes of description only and is without any intention of being limiting. For a reference to WAP, as well as a more detailed explanation, see for example “Programming Applications with the Wireless Application Protocol” (S. Mann, Wiley Computer Publishing, John Wiley and Sons Inc., 1999), incorporated by reference as if fully set forth herein. Furthermore, both the wireless communication device and wireless network which are described below can be viewed as examples of a low bandwidth device and-network for the purposes of the present invention.

A system 10 has a wireless communication device 12 for interacting with a user, which operates a WAP-compatible instruction agent 14, such as a Web browser for example. Web browsers which operate according to WAP are also referred to as “microbrowsers”. Requests are sent from wireless communication device 12 to a WAP proxy server (gateway) 16 through a wireless network 18. As a non-limiting example, wireless communication device 12 is optionally a cellular telephone, while wireless network 18 is optionally a cellular telephone communication channel.

WAP proxy server 16 receives the WAP-compatible request and translates this request into an original network protocol request, for example by translating WAP protocol stack to HTTP and TCP/IP instructions. The translated request is then passed to a Web server 20, which operates such software as CGI scripts 22 and which provides content 24.

The same process may also be followed in reverse when Web server 20 serves the requested content, for example if the requested content is an HTML document. WAP proxy server 16 then receives the requested content from Web server 20, and serves the content to wireless communication device 12.

System 10 also features a portion server 26 according to the present invention. Portion server 26 is shown as being located within WAP proxy server 16, although portion server 26 could also optionally be located at any other location with regard to WAP proxy server 16 and Web server 20. For example, portion server 26 could be located at Web server 20, at a base station between WAP proxy server 16 and wireless communication device 12 (not shown), or at any other location within system 10. It should be noted that WAP proxy server 16, Web server 20 and/or portion server 26 may optionally be operated by the same computational device, even as a single process on that device for servers which are able to transmit WML documents. Each of WAP proxy server 16, Web server 20 and portion server 26 is therefore shown as a separate entity for the purpose of describing the separate functionality only.

Portion server 26 receives a document from a server, such as Web server 20 for example, and then parses the document according to delineated sections in order to divide the document into a plurality of smaller portions. Optionally, portion server 26 could parse WML or binary WML data.

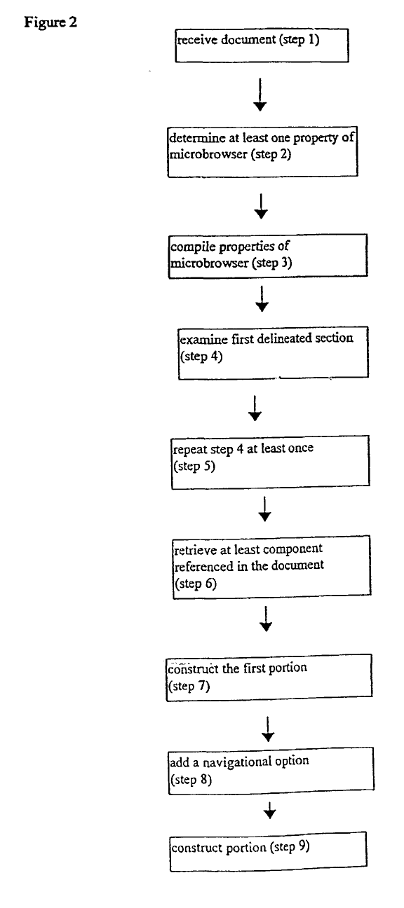

The process of parsing is explained in greater detail with regard to the flowchart in FIG. 2 below. Briefly, the delineated sections are preferably used as a guide when constructing the plurality of portions. For example, if a section is divided over two or more portions, the attributes of that section are preferably assigned to each portion which contains any part of the section, such that the section is displayed with substantially similar or identical attributes even when divided into one or more portions.

Once at least one of the plurality of portions has been prepared, WAP proxy server 16 receives the prepared portion(s), and then transmits a message to WAP-compatible instruction agent 14 through wireless communication device 12. The contents of this message are optionally and preferably determined according to at least one user preference. For example, the user may determine that the message-should always contain the first portion of the document. Alternatively, the message could contain a plurality of titles, each title pertaining to a particular portion. The title could optionally be taken from the first line of text, if available, or simply as a label, such as “image” for a portion which contains a graphical image, for example.

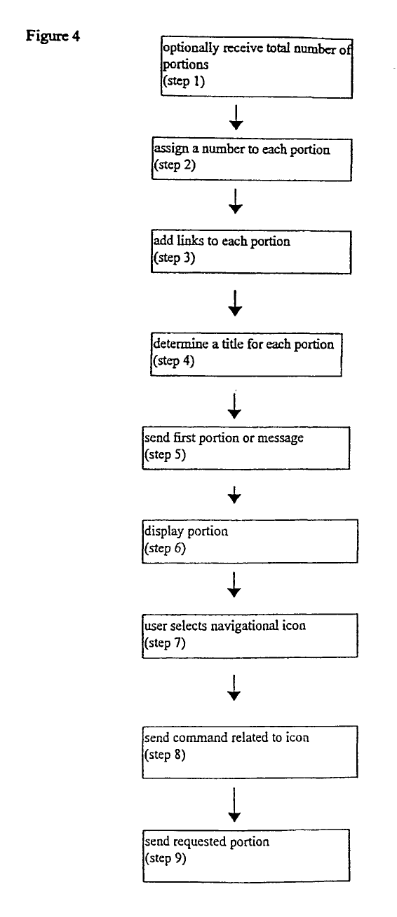

WAP-compatible instruction agent 14 then causes wireless communication device 12 to display the message. If the message contains the first portion of the document, for example, then more preferably WAP-compatible instruction agent 14 also causes one or more navigational controls to be displayed. The user is more preferably able to use these navigational control(s) to cause different portions of the document to be displayed. The process of displaying each portion, and of navigation between portions, is described with regard to the flowchart of FIG. 4 below.

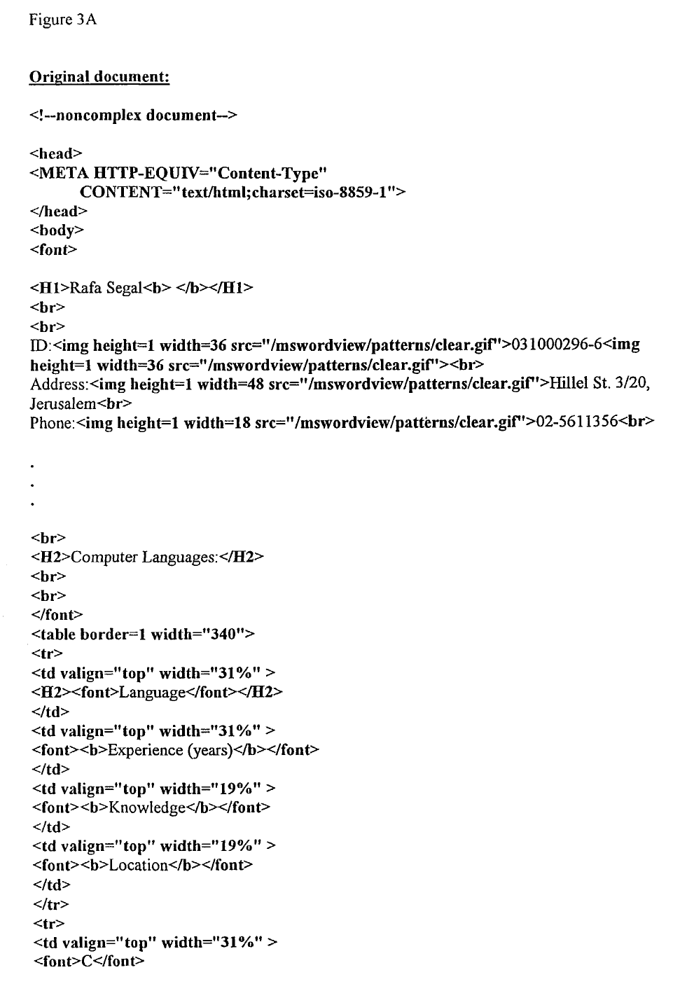

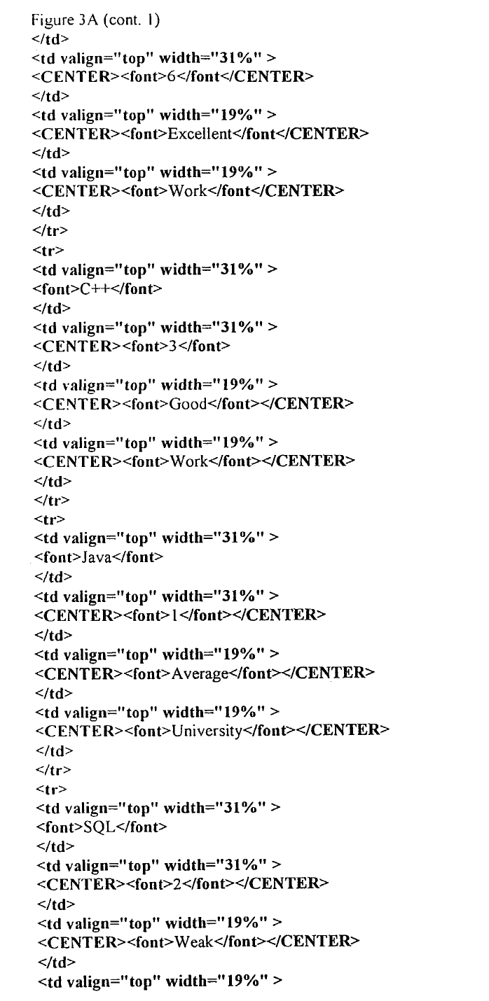

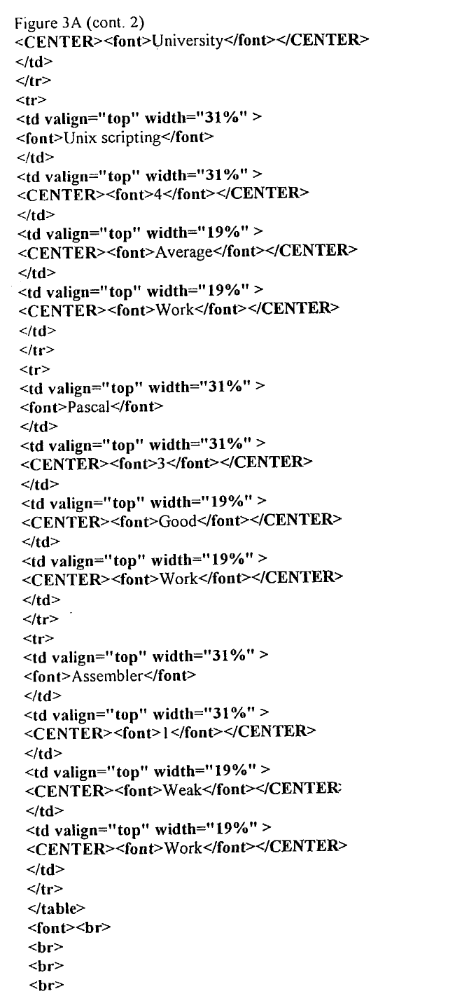

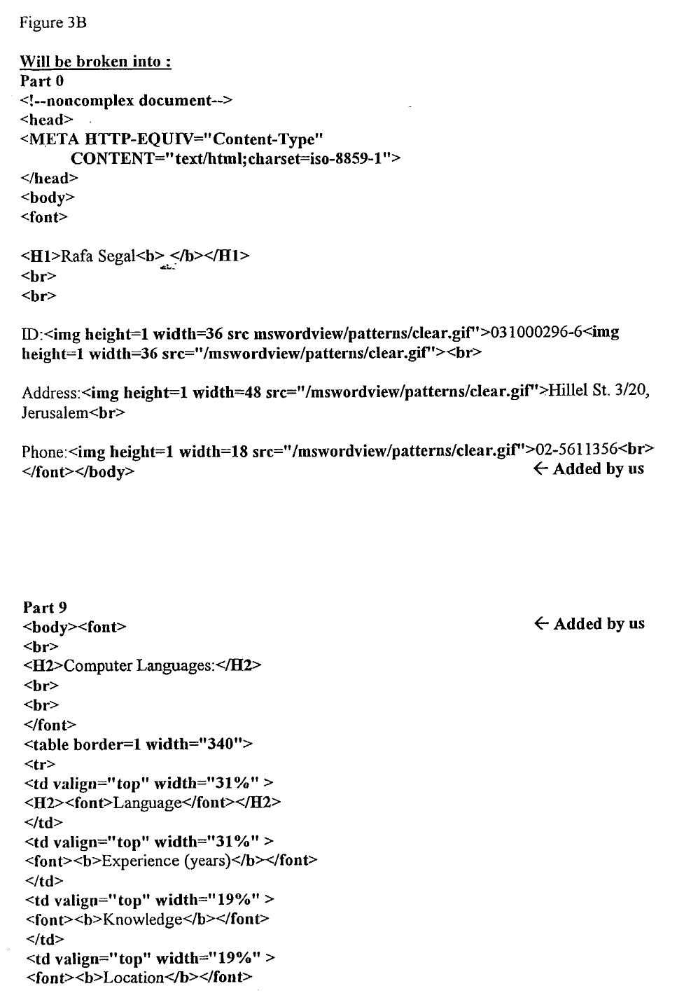

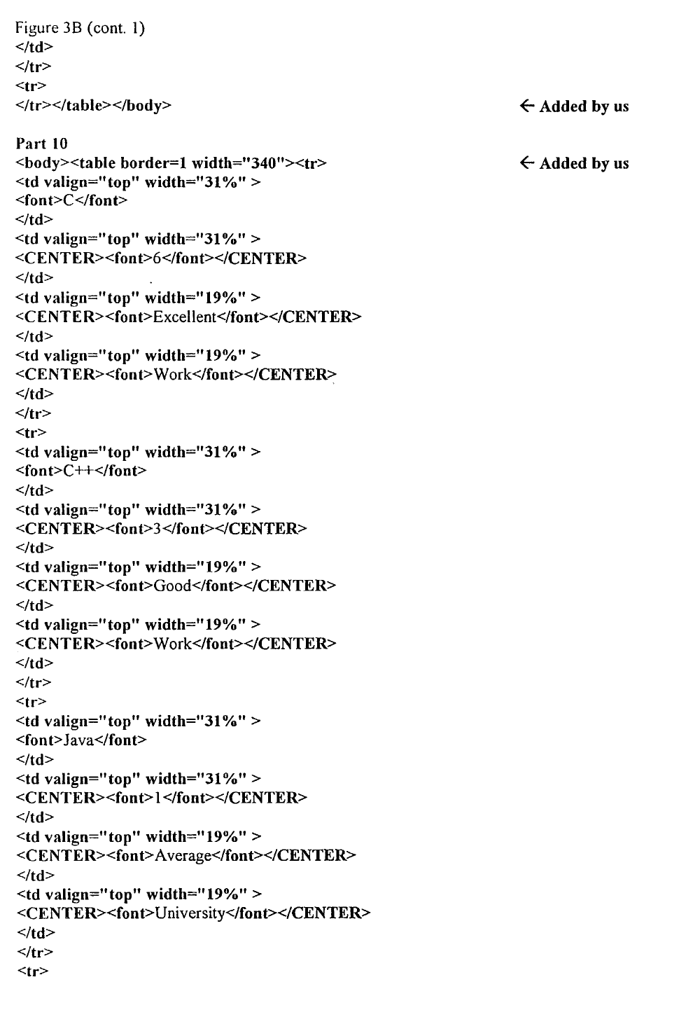

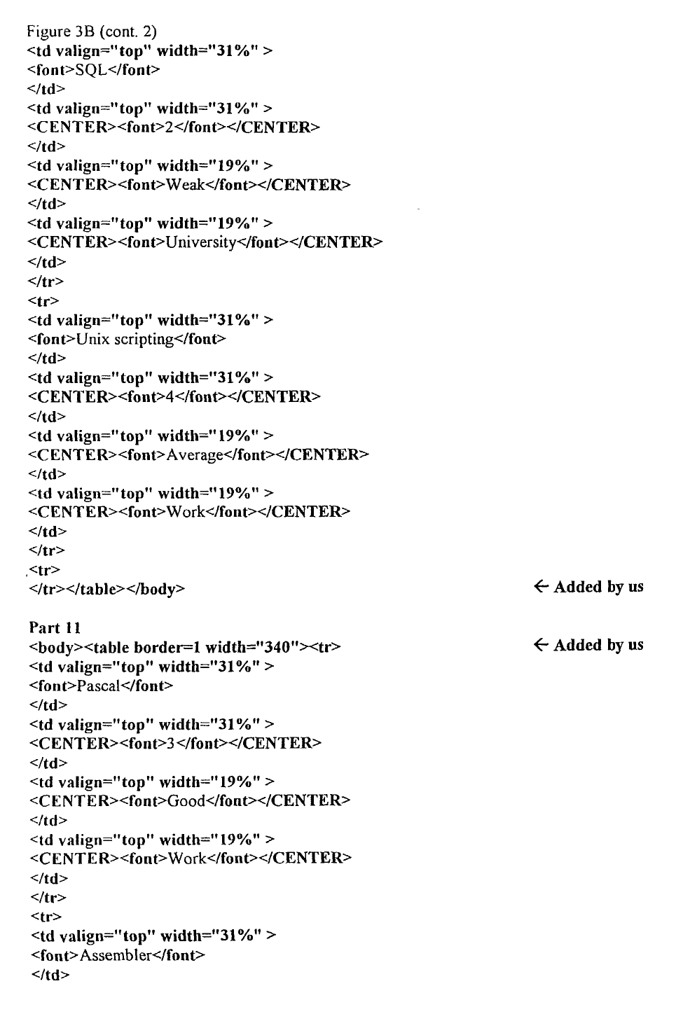

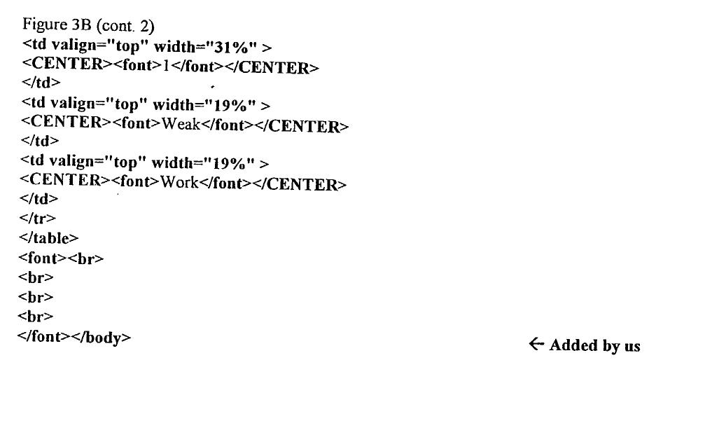

FIGS. 2, 3A and 3B are illustrations for the process of dividing a document into portions. FIG. 2 is a flowchart of an exemplary method according to the present invention for dividing a document into a plurality of portions for display by the wireless communication device, while FIGS. 3A and 3B show part of an exemplary document before (3A) and after (3B) the method of FIG. 2 has been performed. The process of FIG. 2 could optionally be performed “off-line”, before a specific user request for the document is received, or “on the fly”, after such a request has been received.

As shown in FIG. 2, in step 1, a document is received. Preferably, the document contains a plurality of delineated sections as previously described.

In step 2, optionally and preferably, at least one property of the wireless communication device is determined. By “determined” in this step, it is meant that the property is known for the purpose of dividing the document into portions. For example, as described in greater detail below, the property may be retrieved through communication with the wireless communication device itself, and/or with a third party which holds this information regarding the wireless communication device. The property may also optionally be determined through a user defined preference. More preferably, if the property is not received from an external source, the property is determined from a predefined default value. This property may optionally be a property of the hardware, and/or may optionally be a property of a software agent or program being operated by the wireless communication device.

This at least one property may optionally include, but is not limited to, one or more of the following characteristics: available bandwidth to the wireless communication device; microbrowser or software agent type for the software which causes the data to be displayed by the wireless communication device; characteristics which are determined by the capabilities of the wireless communication device such as lines per screen which may be displayed, characters per line, pixels per line, screen resolution, and whether the screen is grayscale or color; available font type(s), whether various types of content are permitted for display such as sound and graphic images; whether the microbrowser is permitted to operate scripts and/or cookies; the level of support, if any, which is provided by the microbrowser for HTML, CSS (cascading style sheets), WAP; and so forth.

Optionally and preferably, such information may be retrieved by some type of automatic process through communication with the wireless communication device, particularly with the microbrowser or other software agent of the wireless communication device. Alternatively and preferably, the information is retrieved from a third party, such as that provided by CC/PP (Composite Capability/Preferences Profiles; see for example http://www.w3c.org/TR/NOTE-CCPP and http://www.w3c.org/TR/NOTE-CCPPexchange). Alternatively, the portion server may retrieve this-information from another source, such as a predetermined and stored set of device and microbrowser characteristics, or else from user-defined preferences with regard to the division of the document into portions, for example.

In step 3, the property or properties of the microbrowser are preferably compiled, in order to determine how each such property affects the display of the portion of the document on the wireless communication device. More preferably, the collected properties with regard to the screen on the wireless communication device itself are mapped to a predetermined portion construction template, in order to more easily construct the portion as described in greater detail below.

In step 4, the first delineated section is examined, which in this case is determined by the first tag. Preferably, this includes determining the attribute or attributes associated with that section. More preferably, the number of characters associated with the section is also determined, optionally with the size or other attribute(s) of the characters, such as the font for example.

Optionally, white spaces and empty lines, collectively referred to as “extraneous spaces”, are removed. If no characters are present, then preferably the size of an associated image is determined, if available, or at least the presence of the image is determined. The information which is gathered during each parsing step is then preferably stored.

In step 5, step 4 is optionally and preferably repeated at least once, and more preferably is repeated until the end of the document is reached.

In step 6, preferably at least one component to which a reference is made within the document is retrieved, or at least is requested. This step is relevant to images, which may be given as an URL within the document, but which may need to be retrieved separately from the rest of the document, such as a Web page for example. Such images may also optionally be sent with the Web page in a: MIME (Multipurpose Internet Mail Extensions) multipart message (see below for a more detailed description). More preferably, step 6 is repeated until all of the referred components of a particular type are retrieved, particularly with regard to images, in order to reduce the number of “GET” requests to the server which has transmitted the document.

In step 7, the first portion is constructed from the parsed data. As previously mentioned, the property or properties related to the display screen of the wireless communication device are preferably compiled, in order to be able to map these properties to a predetermined template. The template is able to receive each character and/or image to be displayed, and to place the character and/or image within the display screen. For example, characters are received for each line until the line has been filled. At that point, preferably a line break symbol is added, such as a line break tag for example, in order to indicate that the end of the line has been reached.

Also more preferably, the template is adjustable during the process, such that if a particular component of the document occupies a larger amount of space than an “average” line of the display, the remainder of the template is adjusted to account for the extra required space: For example, if the component is an image, optionally the remainder of the template is adjusted in order to cause any additional text to wrap around the image, by reducing the length of at least one line next to the image. These adjustments are then optionally stored as differences from the template.

Alternatively, each portion may be flexibly constructed according to the number of horizontal and vertical pixels on the display screen of the wireless communication device. The parsed data would then need to be examined with regard to attributes of the delineated section. The attributes themselves are described in greater detail below. The amount of space which each attribute causes the text and/or image to occupy is preferably determined. These attributes include, but are not limited to, font type and height; spacing between the lines; the size of the image in terms of the height and width in pixels; the size of any borders or separations; and so forth.

Preferably, the attribute(s) of the delineated section associated with the parsed data are also constructed, such that these display attributes are preserved when displaying the portion on the display screen.

Optionally and more preferably, tags and other attribute commands are not included in the determination of length and number. Alternatively, these attribute commands could be included in a calculation of a total size of the portion, if the size of the portion itself is to be determined rather than the characteristics of the displayed data. Also alternatively, certain attributes, such as paragraph breaks, could be used to help determine the boundary of a portion, for example in order to permit a paragraph to be contained in a single portion, particularly if the size of the displayed data for each portion is allowed to be variable.

More preferably, step 7 features the following steps for constructing a portion from a document which includes tags. In step (i), any tags from the previous portion which also apply to the current data are read, for example in the case where a section has been split between portions. In step (ii), any other tag or tags are read from the parsed data. In step (iii), these tags from steps (i) and (ii) are added to the portion, in the order in which they are retrieved from the data.

In step (iv), further data is read and added to the portion, until the end of the available space for the portion is reached. End tags are applied as they are encountered in the parsed data. In step (v), any tags for which end tags have not been applied are determined. In step (vi), the end tags are added to the portion, in the reverse order to which the tags were initiated. In step (vii), these tags are stored for being added to the beginning of the next portion, as for step (i). The actual tags themselves should not be split between portions.

According to preferred embodiments of the present invention, these steps are adjusted for the parsing and displaying of tables. In particular, as a portion may not be able to contain an entire table, then preferably the number of columns, and their properties, and/or the number of rows, and their properties, are stored during the parsing process. For example, if a table contains rows which are too long (horizontally) for display within a single portion, then preferably those columns which are not displayed within that portion are added to the next portion, with their associated properties.

Rows which are too wide (vertically) for display within a single portion need to be split within each cell, in order to place a first part of the cell in a first portion, a second part of the cell in a second portion and so forth.

In step 8, if a portion is to feature navigational icons or links, which are examples of a “navigational option”, these items are preferably added to the portion. Since these items do require space for display, they must be considered when determining the total display size for the data of the portion. Furthermore, the type and size of images may differ between microbrowsers or other software agents, particularly if locally stored images are used, as indicated with the localsrc attribute of the image in WML, for example. These attributes of the images need to be considered when constructing the portion. In addition, not all software agents and/or wireless communication devices support images, such that in the place of an image, a text string may be displayed, which again affects the size of the portion.

In step 9, once a portion has been constructed, it may optionally be sent to the wireless communication device. However, preferably all of the portions are constructed before any portion is sent to the wireless communication device, for ease of navigation as described in greater detail with regard to FIG. 4 below.

According to another preferred embodiment of the present invention, at least one portion is preferably received in the background as a previous portion is being displayed. The identification of a particular portion for downloading can be determined according to an analysis of the behavior of the user with regard to receiving portions. For example, if a user typically requests the next sequential portion, such a portion is more preferably downloaded in the background.

Receiving such data by the display device in the background can be performed in a number of different ways. For example, a Java applet or other such software module may be installed at the display device, which would pre-load one or more portions. Alternatively, JavaScript/WMLScript (or any other scripting language) may optionally be used to pre-load the portion which is received in the background. Also alternatively, HTML, WML, or the relevant meta-language tags may optionally be used to pre-load the images, although this may be quite Web browser-dependent.

For example, in Internet Explorer™ 4.0, the following HTML code loads the main Web page of the Web site “www.google.com” into the cache (but does not show anything):

<object classid=“http://www.myplace.com/icons/start.gif” data=“http://www.google.com”>Show this if your browser does not support the OBJECT tag</object>

It should be noted that the GIF (graphic interchange format) file specified in the “classid” field must be a valid URL for that GIF file.

Yet another implementation could be performed by using frames, such that the “next” Web page could be loaded in a small or hidden frame. Simple Web browsers, such as those found on the Nokia 9110™ which uses HTML over HTTP commands, or microbrowsers for example which use WML, may not support frames, or display links to the frames.

FIGS. 3A and 3B show part of an exemplary document before (3A) and after (3B) the method of FIG. 2 has been performed. As shown in FIG. 3A, the document is written in HTML, and therefore contains a number of tags, along with text.

FIG. 3B shows the same part after the method of FIG. 2 has been performed. Tags which have been added during the performance of this method are indicated with an arrow and the label “added by method”, and each portion is indicated with a “portion” label and a number. Clearly, the method is able to add tags to each portion as necessary, in order for all data to which the tags apply to be indicated.

FIG. 4 is a flowchart of an exemplary method for navigating between portions according to the present invention. In step 1, preferably the total number of portions is received from the process of FIG. 2, although optionally navigational capabilities could be added to each portion as it is constructed. Also optionally, each portion could be constructed “on the fly” and received from the process of FIG. 2.

In step 2, a number is assigned to each portion, indicating the location of the portion within the sequence of portions. In step 3, a link from the current portion to the previous portion is provided, as well as a ink from the current portion to the next portion. Optionally, links to other portions are provided, for example to a portion which is located five portions away from the currents portion, and so forth.

In step 4, optionally and preferably, a title is determined for each portion, for example from the first line of text, if any, as previously described. Such a title is preferably determined if a message is sent to the user which contains a list of the portions with titles, as previously described.

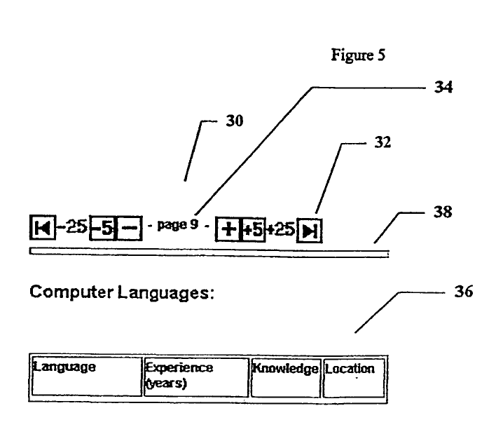

In step 5, either the first portion, or a message containing a list of portions, is sent to the user. Assuming that a portion is sent to the user, then in step 6, the portion is displayed as shown in FIG. 5 below. The display preferably contains navigational icons and/or link indicators, in order for the user to be able to select a different portion.

According to preferred embodiments of the present invention, the user is able to navigate through the portions according to commands entered through a mapping of certain keys on the keypad of the wireless communication device, such that each key displays the navigational option. For example, the numeric key “9” could optionally be mapped to the “page down” command, the numeric key “3” could optionally be mapped to the “page up” command, the numeric key “1” could optionally be mapped to the “end of document” command for moving to the last portion of the document, the numeric key “5” could optionally be mapped to the “start of document” command for moving to the first portion of the document, the numeric key “2” could optionally be mapped to entering a page number for the portion of interest, and the numeric key “4” could optionally be mapped to entering a text string to search for the portion of interest. Of course, other mappings are also possible within the present invention.

Also preferably, the portion is sent as a MIME (Multipurpose Internet Mail Extensions) multipart message if text is combined with one or more graphic images, in order for the portion to be received as a single unit, without requiring the microbrowser to retrieve the graphic image separately. Such a multipart message contains the text and the graphic image(s), separated by separators.

In step 7, the user indicates a particular icon or link for retrieving a different portion. In step 8, a command is sent from the wireless communication device of the user to the server. In step 9, the requested portion is sent to the wireless communication device, if the portion has not yet been received by the device. However, at least for the implementation of the present invention with cards and WML, portions which have already been received by the wireless communication device can be retrieved again with predefined commands from local storage. For example, the “<prev>” element of WML is used to navigate to the previous card. This process is optionally repeated until the user has viewed all of the document and/or terminates the request.

FIG. 5 is an exemplary display of a portion by a display screen of a wireless communication device according to the present invention. As shown, a top segment 30 of the display includes at least one, but preferably a plurality of, navigation icons 32 or other navigation indicators. In addition, top segment 30 also preferably features a portion number 34, for indicating the number of portion within the sequence of portions.

A display segment 36 shows the data for the portion itself, in this case featuring text with formatting. Optionally, display segment 36 may be separated from top segment 30 by a border separator 38.

It will be appreciated that the above descriptions are intended only to serve as examples, and that many other embodiments are possible within the spirit and the scope of the present invention.

What is claimed is:

1. A method for dividing a document into a plurality of portions for display to a user, the method comprising the steps of:
(a) providing a display device for displaying at least one portion to the user and a network connected to said display device;
(b) determining at least one property of said display device;
(c) dividing the document into the plurality of portions, such that each portion is at least partially determined according to said at least one property of said display device;
(d) receiving at least one portion of the plurality of portions through said network by said display device; and
(e) displaying said at least one portion by said display device.

2. The method of claim 1, wherein said display device is a wireless communication device, and said network is a wireless network.

3. The method of claim 2, wherein said wireless communication device is a cellular telephone, and said wireless network is a cellular telephone network.

4. The method of claim 3, wherein said at least one property of said cellular telephone is a size of a display screen of said cellular telephone.

5. The method of claim 3, wherein said at least one property of said cellular telephone is an amount of bandwidth available on said cellular telephone network.

6. The method of claim 1, wherein the document features a plurality of delineated sections, each delineated section having at least one attribute, such that each portion of the plurality of portions features said at least one attribute.

7. The method of claim 6, wherein the document is written in a mark-up language, said mark-up language featuring a plurality of tags, each tag corresponding to an attribute, such that step (c) further comprises the steps of:
(i) detecting a start for each tag;
(ii) applying said attribute to said portion; and
(iii) if said portion ends before an end tag is detected, generating a generated end tag for said portion.

8. The method of claim 7, wherein step (c) further comprises the steps of:
(iv) storing a marker for each generated end tag; and
(v) applying each tag corresponding to said marker to a subsequent portion.

9. The method of claim 7, wherein said mark-up language is WML (Wireless Mark-up Language), such that said display device is a WAP (wireless application protocol) enabled device.

10. The method of claim 1, wherein the document features a reference to at least one additional component, said at least one additional component being external to the document, and step (c) further comprises the steps of:
(i) receiving said at least one additional component; and
(ii) dividing the document also according to said at least one additional component, such that said at least one additional component is included in at least one portion.

11. The method of claim 10, wherein the document features a plurality of references to a plurality of components, and steps (i) and (ii) are performed for all components of a selected type.

12. The method of claim 11, wherein said selected type is a graphic image.

13. The method of claim 10, wherein said at least one portion includes said at least one additional component, such that step (d) includes the step of transmitting said at least one portion and said at least one additional component as a MIME (Multipurpose Internet Mail Extensions) multipart message.

14. The method of claim 1, wherein step (c) further comprises the step of preparing a message containing a list of the plurality of portions and step (d) further comprises the steps of:
(i) sending said message to said display device through said network;
(ii) displaying said message to the user by said display device; and
(iii) selecting said at least one portion for display by the user from said message.

15. The method of claim 1, wherein step (e) includes the step of displaying at least one navigation option for selecting a portion to the user through said display device, the method further comprising the steps of:
(f) selecting said at least one navigation option by the user through said display device; and
(g) retrieving at least one additional portion according to said at least one navigation option.

16. The method of claim 15, wherein the plurality of portions has a sequence, and at least one portion is not displayed by said display device according to said sequence.

17. The method of claim 15, wherein said at least one navigation option is selected from the group consisting of an icon and a link.

18. The method of claim 15, wherein said display device has a keypad with a plurality of keys, at least one key being mapped to a navigation option, and said at least one navigation option is selected through a key on said keypad, such that said at least one navigation option is displayed by said key.

19. The method of claim 15, wherein said navigation option is selected by entering a keyword by the user for performing a search, such that at least one portion corresponding to said keyword is selected.

20. The method of claim 1, wherein said display device is a low bandwidth communication device.

21. The method of claim 1, wherein steps (b) and (c) are performed in advance, before the user requests the document.

22. The method of claim 1, wherein the document features at least one extraneous space, such that step (c) further comprises the step of removing said least one extraneous space from said at least one portion.

23. The method of claim 1, further comprising the step of:
(f) receiving at least one additional portion while displaying said at least one portion of step (e).

24. A system for dividing a document into a plurality of portions for display to a user, the document featuring a plurality of delineated sections, each delineated section featuring at least one attribute, the system comprising:
(a) a low bandwidth communication device for displaying at least one portion to the user, said low bandwidth communication device having at least one property;
(b) a server for dividing the document into the plurality of portions at least partially according to said at least one property, such that each portion features at least one attribute of a corresponding delineated section of the document, and for sending at least one portion to said low bandwidth communication device; and
(c) a network for connecting said low bandwidth communication device to said server.

25. A method for navigating within a document by a user, the document being divided into a plurality of portions, the method comprising the steps of:
(a) providing a low bandwidth device for displaying at least one portion to the user;
(b) adding a navigation option to at least one portion of the plurality of portions,
(c) displaying said navigation option by said low bandwidth device;
(d) selecting said at least one portion by the user with said navigation option;
(e) receiving said at least one portion by said low bandwidth device; and
(f) displaying said at least one portion by said low bandwidth device.
